(19) United States
(12) Patent Application Publication
(10) Pub. No.: US 2005/0027637 A1
(43) Pub. Date: Feb. 3, 2005

(54) Systems and methods for airline ticket sales

(76) Inventor: Gary S. Kohler, Minnetonka, MN (US)

Correspondence Address: Schwegman, Lundberg, Woessner & Kluth, P.A., P.O. Box 2938, Minneapolis, MN, 55402, US

(21) Appl. No.: 10/630,000

(22) Filed: Jul. 29, 2003

(51) Int. Cl. G06F 17/60

(52) U.S. Cl. 705/37

(57) ABSTRACT

A system and method for selling airline tickets. This system and method includes receiving in a first information processing device a bid for airline travel including an amount the bidder is willing to pay per unit of distance flown and determining whether the bid is acceptable to a seller of air travel services. Further, there is also provided a system and method for selling airline tickets wherein the cost is determined using an X+Y pricing scheme. An X+Y pricing scheme determines the cost based on factors including a fixed cost factor “X” and/or a variable cost factor “Y” based on a unit of distance. Some embodiments require the purchase of a subscription to bid on airline travel. Further, pricing schemes that allow more accurate and rational pricing of airline travel based on actual cost factors of providing airline travel as a service to consumers is disclosed.

### TECHNICAL FIELD

This inventive subject matter relates to the field of transportation, more specifically, technical systems and methods for use in the airline industry.

### TECHNICAL BACKGROUND

Airline tickets are most often offered for sale at a price established by an airline based on the airline's cost structure and competition. This pricing system often appears “irrational” to the consumer as it is usually heavily influenced by factors other than the distance traveled. For instance, a ticket to a far away destination will often be cheaper than a ticket to a closer destination. As a result, the consumer is typically presented with a bewildering array of ticket prices for any given route.

According to a more recent pricing approach made popular by Priceline.com, travelers can “name their own price” for a ticket to reach a desired destination. The Priceline.com system, for example, takes the offer, which includes a price offered by the traveler, and attempts to find an airline or other ticket seller that is willing to sell the ticket at the price offered.

### SUMMARY OF THE INVENTIVE SUBJECT MATTER

According to one example embodiment of the inventive subject matter disclosed herein, there is provided a system and method for selling airline tickets. This system and method includes receiving in a first information processing device a bid for airline travel, wherein the bid includes an amount the bidder is willing to pay per unit of distance flown and determining whether the bid is acceptable to a seller of air travel services. Further, there is also provided a system and method for selling airline tickets wherein the cost is determined using an X+Y pricing scheme. An X+Y pricing scheme determines the cost based on factors such as a fixed cost factor “X” and/or a variable cost factor “Y” based on a unit of distance. Some embodiments require the purchase of a subscription in order to bid on airline travel. Further, pricing schemes that allow more accurate and rational pricing of airline travel based on actual cost factors of providing airline travel as a service to consumers is disclosed.

### BRIEF DESCRIPTION OF THE DRAWINGS

FIG. 1 shows a flow diagram according to an embodiment of the inventive subject matter disclosed herein.

FIG. 2 shows a flow diagram according to an embodiment of the inventive subject matter disclosed herein.

FIG. 3 shows a block diagram of an information processing system according to an embodiment of the inventive subject matter disclosed herein.

FIG. 4 shows a flow diagram according to an embodiment of the inventive subject matter disclosed herein.

FIG. 5 shows a flow diagram according to an embodiment of the inventive subject matter disclosed herein.

FIG. 6 shows a block diagram of an information processing system according to an embodiment of the inventive subject matter disclosed herein.

FIG. 7 shows a flow diagram according to an embodiment of the inventive subject matter disclosed herein.

FIG. 8 shows a block diagram of an information processing system according to an embodiment of the inventive subject matter disclosed herein.

FIG. 9 shows a flow diagram according to an embodiment of the inventive subject matter disclosed herein.

FIG. 10 shows a flow diagram according to an embodiment of the inventive subject matter disclosed herein.

### DETAILED DESCRIPTION

In the following detailed description of the preferred embodiments, reference is made to the accompanying drawings that form a part hereof, and in which are shown by way of illustration specific embodiments in which the inventive subject matter may be practiced. It is understood that other embodiments may be utilized and structural changes may be made without departing from the scope of the inventive subject matter hereof.

The leading digit(s) of reference numbers appearing in the Figures generally corresponds to the Figure number in which that component is first introduced or most fully described. Signals and connections may be referred to by the same reference number or label, and the actual meaning will be clear from its use in the context of the description.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired.

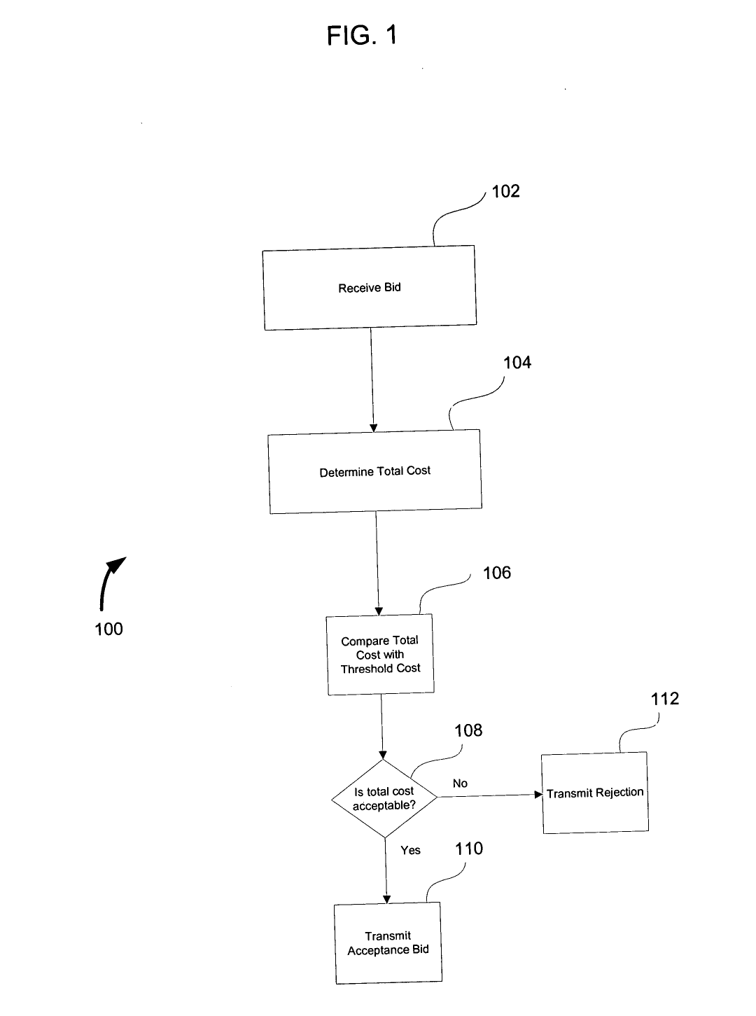

FIG. 1 shows an exemplary embodiment of a method 100 for receiving 102 and accepting 110 bids for airline travel. Method 100 provides a pricing mechanism that allows for more accurately and rationally pricing of airline travel based on cost factors of providing airline travel as a service to consumers. This embodiment of method 100 includes receiving 102 a bid, for example in a computing system, determining 104 the total cost of the bid, comparing 106 the total cost with a threshold cost, determining 108 if the bid is acceptable and either transmitting 110 a bid acceptance if the bid is acceptable or transmitting 112 a bid rejection if the bid is not acceptable.

In some embodiments, a received 102 bid includes a destination location and an origin or departure location. A received 102 bid in some other embodiments includes a cost element. A cost element in some embodiments includes a cost a potential purchaser is willing to pay. In some of these embodiments, the cost element the potential purchaser is willing to pay is expressed as a cost per mile or other unit of measure such as kilometers, meters, minutes or hours of flight time, or other similar units of measure for distance or time.

Method 100 further includes determining 104 a total cost for airline travel for a received 102 bid. In some embodiments, a total cost includes a fixed cost elements and a variable cost element. A variable cost element in some embodiments of method 100 includes a cost based on a flight distance of airline travel. In various embodiments, the variable cost is based on a variable such as engine wear from airline travel, maintenance required or performed for airline travel, fuel requirements for airline travel, and pilot flight time. Some other embodiments include a combination of these variables when determining the variable cost. Some embodiments of method 100 include a fixed cost element that is a certain amount for all airline tickets. In various embodiments, the fixed cost is based on one or more costs including a transaction cost, airport gate costs, boarding costs, back office costs, printing costs, food and beverage costs, airport costs, terminal costs, and various other costs charged in connection with airline travel.

A total cost in some embodiments of method 100 includes a total cost calculated by adding the fixed cost and the variable cost. In other embodiments of method 100, the total cost comprises only the variable cost. In some further embodiments, the total cost includes only fixed costs.

In some embodiments, calculating the variable cost includes determining a distance or flight time between a received origin and destination and multiplying that distance or time by the cost element received 102 in a bid. For example, a bid is received 102 with a variable cost bid of $0.25 per mile and the distance between a received 102 origin and destination is 2,000 miles. The variable cost for mileage is then determined by multiplying $0.25 by 2,000 miles for a product of $500.00. In calculating the total cost of this embodiment, a fixed cost portion is added to the calculated variable cost. In various embodiments, the fixed cost is a transaction cost or a broker fee/cost. Thus, in some embodiments the total cost is determined 104 by adding a fixed cost portion and a variable cost portion based on a cost per unit of distance multiplied by the amount of the unit of distance. This will be referred to as “X+Y pricing.” For example, a bid is received 102 for 2,000 miles of travel at $0.25 per mile and the fixed cost portion is $25.00. According to an embodiment of method 100, the cost is determined by adding the X portion (the fixed cost portion) $25.00 and the Y portion (the variable cost calculated by taking the product of the distance and the cost per unit of distance or $0.25×2,000=$500.00) for a sum of $525.00. In some embodiments, a total cost includes all taxes, airport fees, and other fees, taxes, charges, surcharges, and all other costs. In some other embodiments, no taxes, fees, or other charges are included in a determined 104 total cost.

A determined 104 total cost of a received 102 bid is then compared 106 against a threshold cost. In some embodiments, the threshold cost is a general cost per mile for all airline tickets. In other embodiments, the threshold cost is a cost associated with a specific airline route between two locations. In some further embodiments, a threshold cost is a cost associated with each leg of airline travel having more than one leg. Yet some further embodiments include a threshold cost that correlates to an operational break even point of an airline to offer a seat for sale or for an airline ticket seller to offer a seat for sale. In some embodiments, the comparison 106 of a determined 104 total cost and a threshold cost determines 106 if the total cost is equal to or greater than or equal to the threshold cost. If so, in some embodiments, a bid is acceptable. If not, in some embodiments, the bid is not acceptable. Some other embodiments require a total cost to be greater than the threshold cost by a certain factor such as two percent. Some further embodiments require that the total cost be no more than a certain factor less than the threshold cost such as three percent in some embodiments or $10.00 in some other embodiments. In some other embodiments, the comparison 106 compares a received 102 bid variable cost per unit distance with a threshold cost per unit distance.

When a received 102 bid is acceptable, an acceptance is transmitted 110. In some embodiments, a bid acceptance includes an indicator that a bid is accepted. Some embodiments include a request for airline ticket purchase information with a transmitted 110 acceptance. In some embodiments, airline ticket purchase information includes name, address, telephone number, email address, seat preference, credit card information, checking account or other bank account information, passport information, and other similar information that an airline may need to know for passengers and a ticket seller may need for completing an sale of an airline ticket.

When a received bid 102 is not acceptable, a rejection is transmitted 112. In some embodiments, a bid rejection includes a statement that the bid is rejected. In some other embodiments, a bid rejection includes a counteroffer for the airline travel of a received 102 bid. In further embodiments, an option to edit a received 102 bid is transmitted 112 along with a bid rejection.

In some implementation of embodiments of method 100, bids are received only from members of a group. Some such embodiments require members of the group to pay a membership or subscription fee in order to bid for airline travel. Some further embodiments require members/subscribers to pay a renewal fee after a certain period of time such as twelve months.

Such implementations where only members are allowed to bid for airline travel, further require bidders to submit information to ensure the identity of a bidder. Some embodiments transmit a request for identity information such as a userid and password. Other embodiments request an email address and password. Other embodiments request other information that allows an information processing device having executable instructions for performing the operations of method 100 to ensure the identity of a bidder.

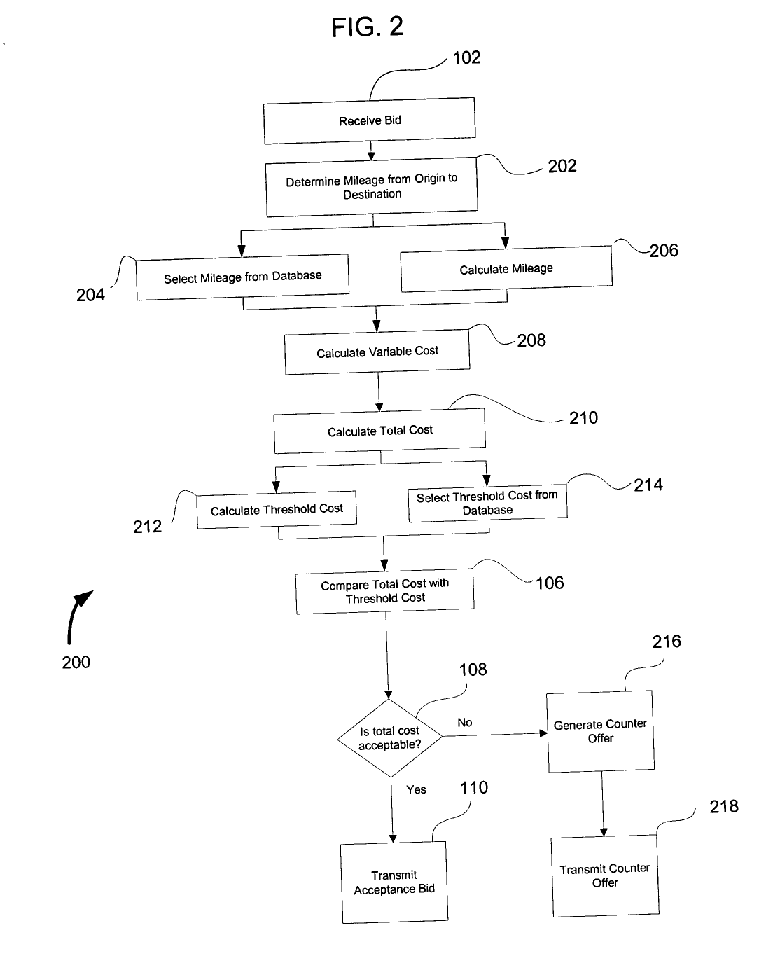

FIG. 2 shows another embodiment of a method 200 according to an embodiment of the inventive subject matter disclosed herein for receiving 102 a bid for airline travel and either accepting 110 or rejecting 216 the received 102 bid. In some embodiments, method 200 includes receiving 102 a bid including an origin and a destination, determining 202 a mileage between the origin and the destination by either selecting 204 the mileage from a database or calculating 206 the mileage by other means, calculating 208 the variable cost for mileage (the Y portion of X+Y pricing), and calculating 210 the total cost based on a fixed cost (the X portion) and the variable cost (the Y portion) where the total cost is calculated using X+Y pricing. In one such embodiment, method 200 continues by obtaining a threshold cost by either calculating 212 the threshold cost or selecting 214 the threshold cost from a database, comparing 106 the total cost with the threshold cost, and determining 108 if the total cost is acceptable. If the total cost is acceptable, a bid acceptance is transmitted 110. If the total cost of a received 102 bid is not acceptable, a counteroffer is generated 216 and transmitted 218.

Some embodiments of method 100 and method 200 include receiving 102 bids from an information processing system on an information processing system implementing a method 100 or 200.

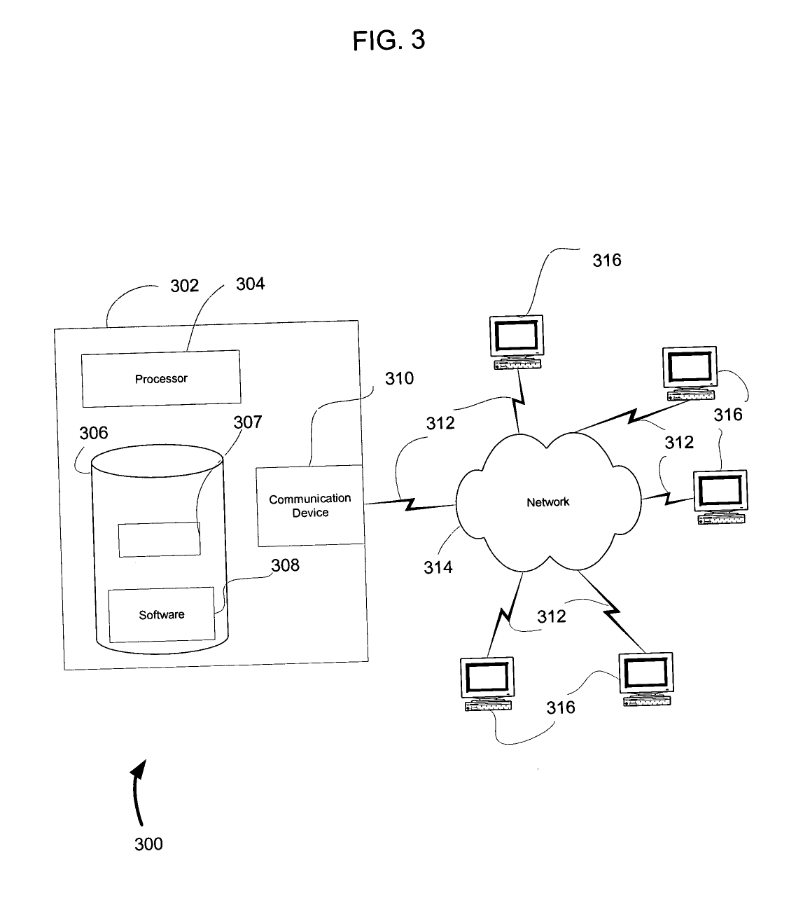

FIG. 3 shows a block diagram of a system 300 according to an embodiment of the present inventive subject matter disclosed herein for receiving 102 bids for airline travel. In some embodiments, system 300 includes an information processing device 302 having a processor 304, a storage device 306, a communication device 310, and software 308. In some embodiments, software 308 includes for maintaining in the storage device 306 a database 307 having one or more variables for determining a threshold cost for airline travel, for receiving a bid for airline travel over communication device 310, for determining the threshold cost using the one or more variable stored in the database 307, for comparing the total cost with the threshold cost, and either transmitting an acceptance or rejection of the bid over the communication device 310. In some embodiments, communication device 310 is operatively connected 312 to a network 314. In some embodiments, network 314 is operative connected to one or more other information processing devices 316.

In some embodiments of a system 300, information processing device 302 is a computer. In some such embodiments, information processing device 302 is an enterprise class server such as a mainframe. In some other embodiments, information processing device 302 is a Windows® (Windows is a registered trademark of Microsoft Corporation of Redmond, Wash.) based computer or other type of computer including reduced instruction set computing (RISC) and complex instruction set computing (CISC) devices.

In some embodiments, storage device 306 is a hard drive. In some other embodiments, storage device 306 is a volatile memory such as random access memory (RAM). In some further embodiments, storage device 306 is non-volatile read only memory (ROM). In still further embodiments of system 300 storage device 306 is a removable computer readable media include a compact disk, a floppy disk, a tape, or any other type of computer readable media.

In some embodiments, database 307 is a flat file. In some other embodiments, database 307 includes a relational database management system such as DB2 available from International Business Machines of Armonk, N.Y. or a transaction and/or hierarchical database management system such as IMS also available from International Business Machines.

In some embodiments, communication device 310 is a network interface card. In other embodiments, communication device 310 includes a wireless network connection, a Universal Serial Bus connection, an IEEE 1394 connection to one or more other information processing devices 316, or other similar wired or wireless connection device. Communication device 310 operatively couples information processing device 302 to a network 314. Network 314 in various embodiments includes the Internet, a wide area network (WAN), a local area network (LAN), a wireless network, a virtual private network (VPN), or other similar arrangement of information processing devices operatively connected for sharing and distributing information and/or processing. Information processing device 316 includes, in various embodiments, a personal computer, a mobile telephone, a handheld computing device, a personal digital assistant (PDA), a home appliance having a smart controller, or other similar information processing device.

In some embodiments of a system 300, information processing device 302 includes software 308. In some embodiments, software 308 includes executable instructions for maintaining and accessing database 307. In some further embodiments, software 308 includes executable instructions for receiving a bids for airline travel from information processing device 316 over a network 312 through a connection 312, determining a threshold cost of airline travel using one or more variables (such as date, time, fuel cost, wholesale ticket cost, . . . ), comparing the total cost of a bid with a threshold cost, accepting a bid if a total cost is within an acceptable range of a threshold cost, and transmitting either an acceptance or rejection of a bid. Some other embodiments further include generating and transmitting a counteroffer for airline travel if a bid is rejected. In some embodiments, a counteroffer is determined based on the threshold cost and X+Y pricing. For example, if a fixed cost portion is $20.00 and a threshold cost per mile is $0.10 per mile, X+Y pricing indicates a threshold cost for 1,000 miles of airline travel to be [$20.00+($0.10×1,000 miles)]=$120.00. In some embodiment, the counteroffer is the $120.00 threshold cost. In other embodiments, the counteroffer is based on the product of the threshold cost and another factor such as a profit margin multiplier. For example, a ticket seller may sell tickets at five percent over their threshold cost. Thus, in this example, the counteroffer is $126.00.

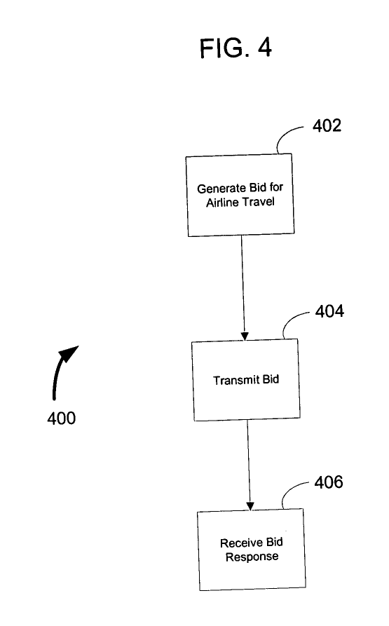

FIG. 4 is a flow diagram of a method 400 for generating a bid for airline travel and receiving a bid response. In some embodiments, method 400 includes generating 402 a bid for airline travel on a first information processing device, wherein the bid includes a fixed cost portion and a cost per unit of distance (X+Y pricing), transmitting 404 the bid from the first information processing device to a second information processing device over a communication link, and receiving 406 a bid response on the first information processing device from the second information processing device over the communication link. In some embodiments, the second information processing system is a system implementing an embodiment of method 100 or method 200 shown in FIG. 1 and FIG. 2 respectively and described above. In various embodiments, the first information processing device of method 400 is a personal computer, a handheld computing device, a mobile phone, a personal digital assistant (PDA), or other similar information processing device.

In some embodiments, a generated 402 bid for airline travel includes an origin and a destination. In some other embodiments, a generated 402 bid for airline travel includes a date and time for airline travel, a seat preference, an origin, and a destination. Some further embodiments include airline ticket purchase information of the purchaser and or traveler such as credit card information, name, address, telephone numbers, emergency contacts, and other information needed by an airline ticket seller, airline, travel insurer, or other involved party.

In some embodiments, a bid is transmitted 404 from an information processing device implementing an embodiment of method 400 over a computer network. In some embodiments, the computer network is a wired network while in other embodiments the network is wireless. In yet further embodiments, the network is a hybrid of wired and wireless.

In some embodiments of method 400, a bid response received 406 includes receiving 406 a bid acceptance if a submitted bid is acceptable and receiving 406 a bid rejection if a submitted bid is not acceptable. In some further embodiments, a counter offer for the same airline travel bid on is received 406 if the bid is not acceptable.

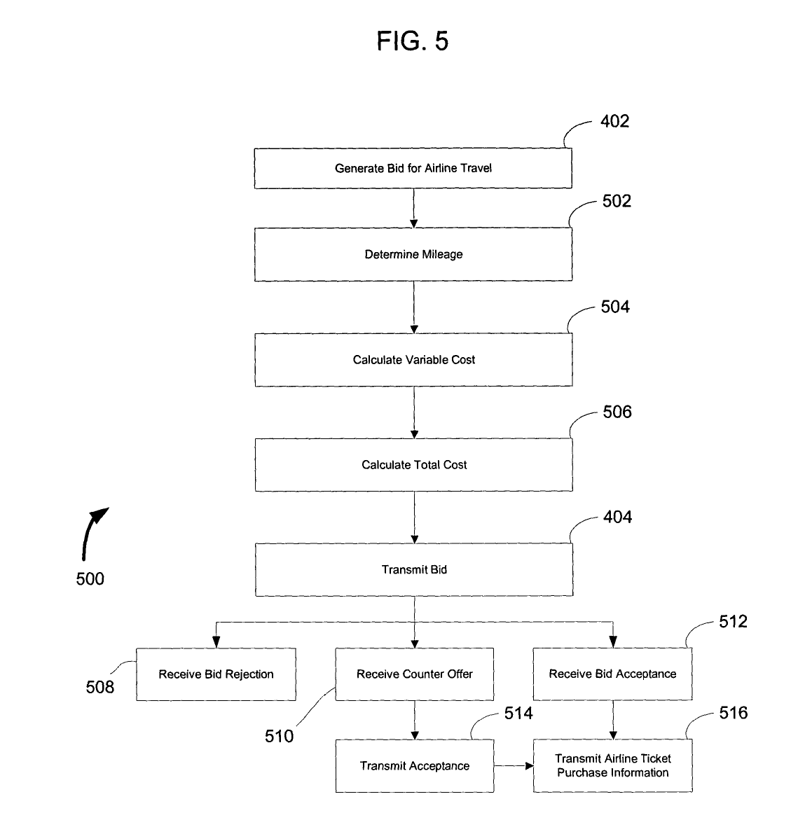

FIG. 5 shows a method 500 for generating 402 a bid for airline travel according to another embodiment of the inventive subject matter disclosed herein. The method 500 embodiment includes generating 402 a bid for airline travel on a first information processing device wherein the bid includes a cost per mile factor (i.e., a variable cost factor) for determining cost, determining 502 a mileage for the airline travel, calculating 504 the variable cost for mileage, calculating 506 the total cost by summing a fixed cost portion and the variable cost portion, transmitting 404 the bid with the total cost from the first information processing device to a second information processing device, receiving 508, 510, 512 either a bid rejection, a counteroffer, or a bid acceptance. In some embodiments, method 500 further includes transmitting 514 an acceptance of a received 510 counteroffer and transmitting 516 airline ticket purchasing information after either transmitting 514 a counteroffer acceptance or receiving 512 a bid acceptance.

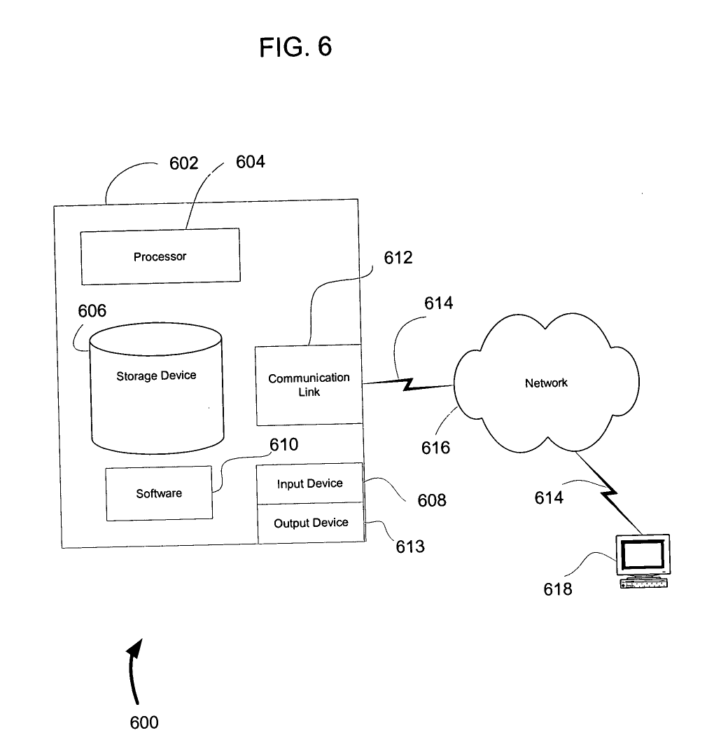

FIG. 6 shows a system 600 for generating a bid or purchase request for airline travel. System 600 includes a first information processing device 602 including a processor 604, a storage device 606, an input device 608, a communication link 612, an output device 613, a network 616, network connections 614, a second information processing device 618, and software 610 operable on the processor of the first information processing device for receiving input for generating a bid or purchase request for airline travel, submitting a bid in a carrier signal over the communication link to the second information processing device, and receiving a response in a carrier signal over the communication link from the second information processing device. In various embodiments, communication link 612 is a network interface device, a wireless network device, or another similar device of connecting an information processing device to a network 616. In various embodiments, network 616 is a LAN, a WAN, a VPN, the Internet, or a combination of these network types and/or other types of networks for connecting two or more information processing devices. In various embodiments, input device 608 is a keyboard, a mouse, a stylus used in a stylus or pen computing device, a touch screen, a microphone, or other input device used to enter data or stimulate an information processing device. In various embodiments, output device 613 is a monitor, a display, a printer, an audio device such as a sound card and speakers, a touch output device such as a vibrator in a mobile telephone, or other device that creates symbolic output from an information processing device.

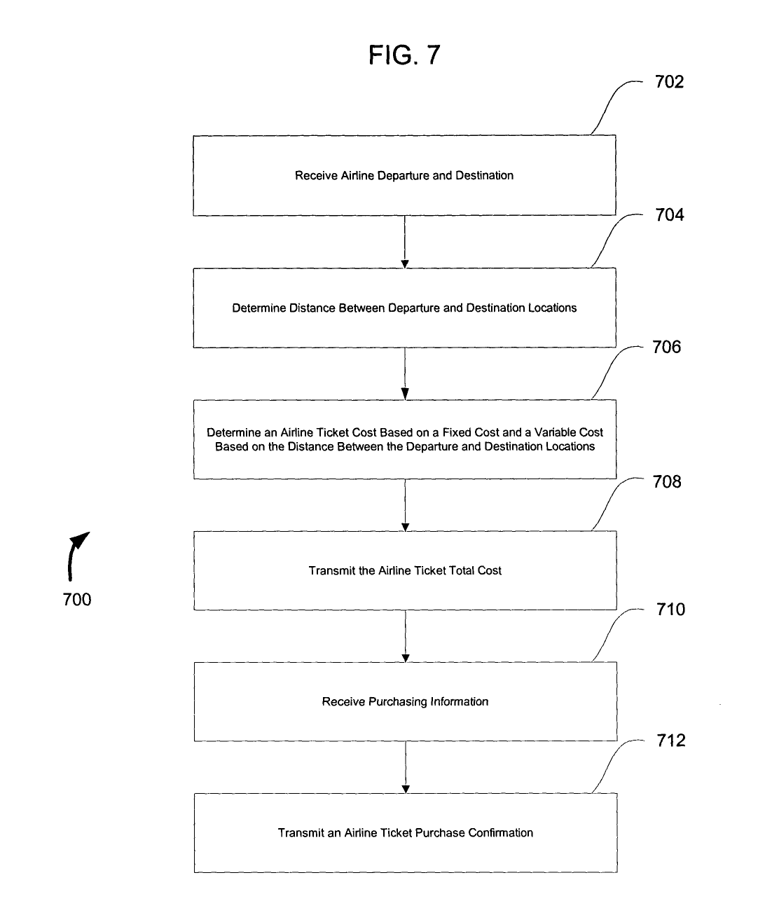

FIG. 7 shows a method 700 for receiving 702 a purchase request for airline travel in an information processing device and purchasing the requested travel. Method 700 includes receiving 702 airline departure and destination locations, determining 704 a distance between departure and destination locations, determining 706 an airline ticket cost based on a fixed cost and a variable cost base on the distance of airline flight (X+Y pricing), transmitting 708 the airline ticket cost, receiving 710 purchase information, and transmitting 712 an airline ticket purchase confirmation. In some embodiments purchase information includes credit card information, name, address, phone number, emergency contact information, and other similar information needed by airlines, security authorities, the ticket seller, and other interest parties. In some embodiments, an airline ticket purchase confirmation is an email containing the details of a purchased ticket and an indication that the sale was completed. In other embodiments, the confirmation is a message transmitted to a ticket purchaser indicating the sale was completed.

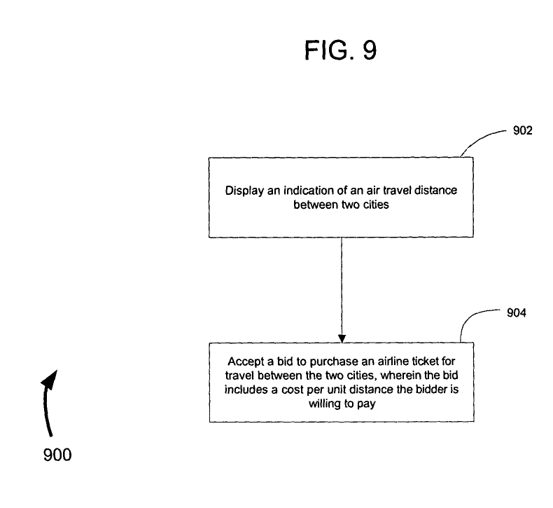

FIG. 9 shows a flow diagram of an embodiment of a method 900 for displaying 902 an indication of distance between two cities and accepting 904 a bid for airline travel between the two cities. In some embodiments, accepting 904 a bid for airline travel includes accepting 904 a bid to purchase an airline ticket for travel between two cities wherein the bid includes a cost per unit distance the bidder is willing to pay. In some such embodiments, the unit of distance is miles while other embodiments utilize kilometers.

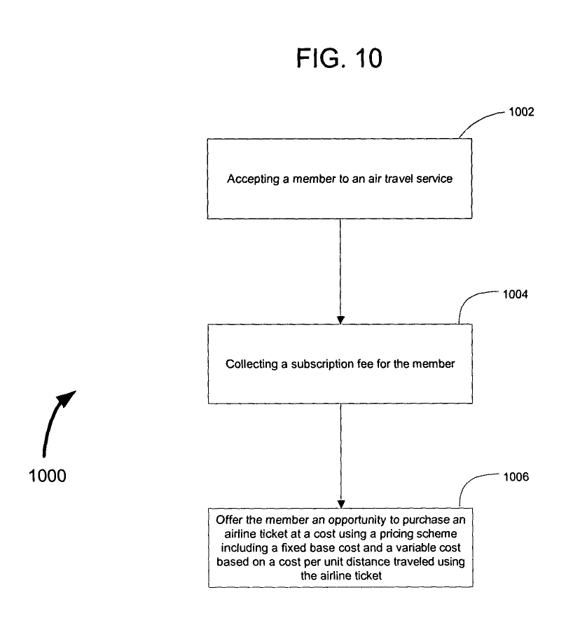

FIG. 10 shows an embodiment of a method 1000 for accepting 1002 a member to an air travel service, collecting 1004 a subscription fee from the member, and offering 1006 the member an opportunity to purchase an airline ticket wherein the ticket is offered for sale using a pricing scheme including a fixed base cost and a variable cost based on a cost per unit distance traveled (X+Y pricing) using the airline ticket. In some embodiments, are multiple subscription levels available at one or more costs. In one such embodiment, a free subscription is available if the subscriber is willing to allow their personal information to be shared with other companies and a paid subscription level where subscriber information is not shared. In other embodiments, there are multiple paid subscription levels that provide subscribers more benefits at higher levels such as access to special airline travel costs, special costs for other travel related items such as hotels, rental cars, luggage, and companion airline travel costs. In some embodiments, the subscription fee is payable as a lump sum payment for a certain period of time such as a year. In other embodiments, the subscription fee is a recurring fee that is payable on a recurring basis such as monthly. In some further embodiments, the subscription fee is credited toward a purchase of airline travel or other products or services provided by an airline travel seller.

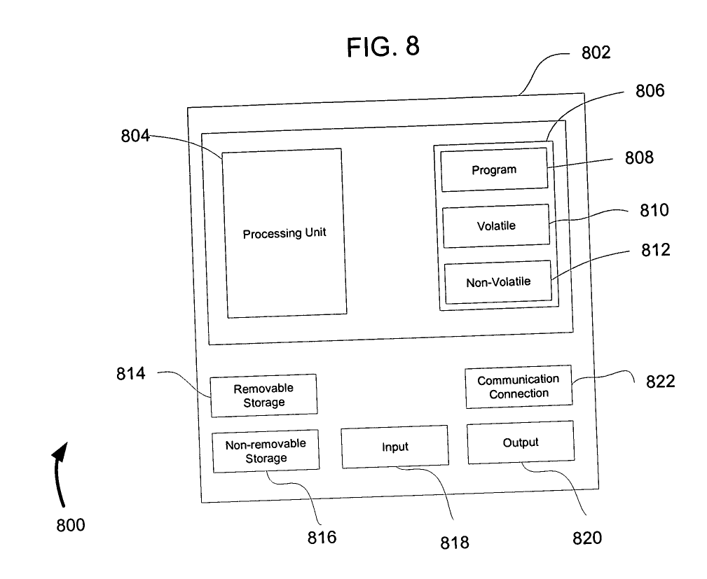

A block diagram of an information processing device capable of executing programming for performing the above methods is shown in FIG. 8. A general information processing device in the form of a computer 802, includes a processing unit 804, memory 806, removable storage 814, and non-removable storage 816. Memory 806 optionally includes volatile memory 810 and non-volatile memory 812. In various embodiments, computer 802 includes a variety of computer-readable media, such as volatile memory 810 and non-volatile memory 812, removable storage 814 and non-removable storage 816. Computer storage comprises random access memory (RAM), read only memory (ROM), erasable programmable read-only memory (EPROM) & electrically erasable read-only memory (EEPROM), flash memory or other memory technologies, compact disk read-only memory (CD ROM), digital versatile disks (DVD) or other optical disk storage, magnetic cassettes, magnetic tape, magnetic disk storage or other magnetic storage devices, or any other medium capable of storing computer-readable instructions. In various embodiments, computer 802 includes or has access to a computing environment that comprises input 818, output 820, and a communication connection 822. The computer 802 operates in a networked environment using a communication connection to connect to one or more remote computers. The remote computer may include a personal computer, server, router, network personal computer (PC), a peer device or other common network node, a wireless computing device, a personal digital assistant (PDA), a mobile telephone, or the like. In various embodiments, the communication connection 822 includes a local area network (LAN), a wide area network (WAN), the Internet, a virtual private network (VPN), or other networks.

Computer-readable instructions stored on a computer-readable medium are executable by the processing unit 804 of the computer 802. A hard drive, CD-ROM, and RAM are some examples of articles including a computer-readable medium. For example, a computer program 808 capable performing operations in accordance with one or more of the methods of the inventive subject matter disclosed herein can be included on a CD-ROM and loaded from the CD-ROM to a hard drive. The computer-readable instructions allow computer system 802 to provide generic access controls in a computer network system having multiple users and servers, wherein communication between the computers comprises utilizing TCP/IP, HTML, XML, Simple Object Access Protocol (SOAP), Web Services Description Language (WSDL), and other communication protocols that provide the ability of two or more information processing devices to communication with one another.

It is understood that the above description is intended to be illustrative, and not restrictive. Many other embodiments will be apparent to those of skill in the art upon reviewing the above description. The scope of the inventive subject matter disclosed herein should, therefore, be determined with reference to the appended claims, along with the full scope of equivalents to which such claims are entitled.

1. A method comprising:
receiving in an information processing device a bid for airline travel, wherein the bid includes an amount the bidder is willing to pay per unit of distance flown; and
determining whether the bid is acceptable to a seller of air travel services.

2. A method comprising:
using a wide area network, displaying to a potential bidder an indication of the air travel distance between two cities; and
accepting a bid to purchase an airline ticket for travel between the two cities, wherein the bid includes a cost per unit distance the bidder is willing to pay.

3. A method according to claim 2, wherein prior to accepting the bid, displaying the total amount bid to the bidder, wherein the total amount bid is calculated at least in part based on the cost per unit distance bid and the distance between the two cities.

4. A method according to claim 1 or 2 wherein the bid further includes a base fee that is fixed in amount.

5. A method according to claim 2 wherein there is further displayed to the bidder a fixed base fee that is required to be paid in addition to the per unit distance fee in order to bid on an airline ticket.

6. A method, comprising:
accepting a member to an air travel service;
collecting a subscription fee for the member; and
offering the member an opportunity to purchase an airline ticket wherein the ticket is offered for sale using a pricing scheme including a fixed base cost and a variable cost based on a cost per unit distance traveled using the airline ticket.

7. A method according to claim 6, further comprising:
using a wide area network, displaying to a member an indication of the air travel distance between two cities; and
accepting a bid from the member to purchase an airline ticket for travel between the two cities, wherein the bid includes a cost per unit distance the bidder is willing to pay.

8. A method, comprising:
maintaining electronic records specifying members to an air travel service;
maintaining electronic records on subscription fees paid by at least some of the members;
using a wide area network, offering the member an opportunity to purchase an airline ticket wherein the ticket is offered for sale using a pricing scheme including a fixed base cost and a variable cost based on a cost per unit distance traveled using the airline ticket.

9. The method of claim 8, wherein the wide area network includes the internet.

10. A method according to claim 8:
using the wide area network, displaying to a member an indication of the air travel distance between two cities; and
accepting a bid from the member to purchase an airline ticket for travel between the two cities, wherein the bid includes a cost per unit distance the member is willing to pay.

11. A system, comprising:
a computing system including electronic records specifying members to an air travel service and including electronic records on subscription fees paid by at least some of the members; and
one or more server computing systems interacting with a client computing system to offer the member an opportunity to purchase an airline ticket wherein the ticket is offered for sale using a pricing scheme including a fixed base cost and a variable cost based on a cost per unit distance traveled using the airline ticket.

12. A system according to claim 11 further wherein the one or more server computing systems interact with the client computer to display to a member an indication of the air travel distance between two cities and to accept a bid from the member to purchase an airline ticket for travel between the two cities, wherein the bid includes a cost per unit distance the bidder is willing to pay.

13. A method comprising:
receiving in a first information processing device a bid for airline travel, wherein the bid includes a fixed cost;
determining a total cost for the airline travel based on a fixed cost plus the cost per mile; and
comparing the total cost with a threshold cost, wherein if the total cost meets or exceeds the threshold cost, the bid is accepted.

14. The method of claim 13, further comprising:
transmitting the accepted bid from the first information processing device to a second information processing device.

15. The method of claim 13, further comprising:
requesting identity information, wherein the identity information is used to identify the source of a bid; and
ensuring the source of the bid is an authorized source, wherein an authorized source is a source that has paid a membership fee for the privilege of bidding on airline travel on the first information processing device.

16. The method of claim 13, wherein the bid further includes an origin, a destination, and a date for travel.

17. The method of claim 16 further comprising:
calculating a mileage between the origin and the destination.

18. The method of claim 17 further comprising:
determining the threshold cost based on the fixed cost plus a threshold cost per mile.

19. The method of claim 18, wherein the threshold cost per mile is dependent on the origin and destination.

20. The method of claim 16 further comprising:
selecting a mileage between the origin and the destination from a database accessible by the first information processing device.

21. The method of claim 13 further comprising:
rejecting a bid if the total cost is less than the threshold cost; and
transmitting the rejected bid from the first information processing device to a second information processing device.

22. The method of claim 21 further comprising:
generating a counteroffer for airline travel based on the threshold cost if a bid is rejected;
transmitting the counteroffer for airline travel.

23. The method of claim 22, wherein generating a counteroffer based on the threshold cost includes deriving a counteroffer cost is equal to or greater than the threshold cost.

24. A computer readable medium with instructions thereon that cause a suitably configured information processing device to perform the method of claim 13.

25. A system comprising:
a processor;
a storage device;
a communication link;
software operable on the processor to:
maintain in the storage device a database having one or more variables for determining a threshold cost for airline travel;
receive a total cost bid for airline travel over the communication link, wherein the bid includes a fixed cost and a cost per unit distance of travel;
determine the threshold cost using the one or more variables;
compare the total cost bid with the threshold cost, wherein if the total cost bid meets or exceeds the threshold cost, the bid is accepted; and
transmit the accepted bid over the communication link.

26. The system of claim 25, wherein the software further includes:
request and verify identity information from a source of the total cost bid, wherein only authorized sources are eligible to utilize the system, further wherein a source becomes eligible upon payment of a subscription fee.

27. The system of claim 25, wherein the database is a relational database.

28. The system of claim 25, wherein the communication link is operatively coupled to a network.

29. The system of claim 28, wherein the network is the Internet.

30. The system of claim 25, wherein the one or more variables for determining a threshold cost for airline travel includes a stored threshold cost for airline travel.

31. The system of claim 25, wherein a bid for airline travel includes an origin and a destination.

32. The system of claim 31, wherein the software operable on the processor further includes:
determining the threshold cost for airline travel between the origin and the destination.

33. A method comprising:
generating a bid for airline travel on a first information processing device, wherein the bid includes a cost per mile portion;
transmitting the bid from the first information processing device over a communication link to a second information processing device; and
receiving a bid response on the first information processing device from the second information processing device over the communication link.

34. The method of claim 33, wherein the bid further includes a fixed cost portion.

35. The method of claim 31, wherein the bid further includes an origin, a destination, a date for the airline travel.

36. The method of claim 33, wherein the first information processing device is a personal computer operatively coupled to a global computer network

37. The method of claim 36, wherein the bid is transmitted and the bid response is received over the global computer network.

38. The method of claim 33, further comprising:
determining an airline travel mileage;
calculating the total cost per mile portion by multiplying the airline travel mileage and the cost per mile portion;
summing a fixed cost portion and the total cost per mile portion; and
wherein the transmitting the bid includes transmitting the sum of the fixed cost portion and the total cost portion.

39. The method of claim 33, wherein receiving a bid response includes receiving a bid rejection and a counteroffer for airline travel.

40. The method of claim 39, wherein the counteroffer for airline travel includes a fixed cost portion and a cost per mile portion.

41. The method of claim 39, wherein receiving a bid rejection and a counteroffer for airline travel includes receiving only a counteroffer that operates as a bid rejection and a counteroffer.

42. A computer readable medium with instructions thereon that cause a suitably configured information processing device to perform the method of claim 33.

43. A system comprising:
a first information processing device including:
a processor;
a storage device;
an input device;
a communication link;
software operable on the processor to:
receive input for generating a bid for airline travel, wherein the bid includes a cost per mile portion;
submit the bid in a carrier signal over the communication link to a second information processing device;
receive a response in a carrier signal over the communication link from the second information processing device.

44. The system of claim 43, wherein the response from the second information processing device includes an indication that the bid is accepted.

45. The system of claim 43 further comprising:
an output device; and
software operable on the processor to:
generate an output from the output device in response to receiving a response from the second information processing device.

46. The system of claim 45, wherein the output device is a monitor.

47. The system of claim 43, wherein the input further includes:
an origin;
a destination; and
a date for travel.

48. The system of claim 43, wherein the communication link is operatively coupled to a communication network.

49. The system of claim 48, wherein the communication network is a global computer network.

50. The system of claim 43, wherein the information processing device is a wireless telephone.

51. The system of claim 43, wherein the information processing device is a personal computer.

52. The system of claim 43, wherein the information processing device is a personal digital assistant (PDA).

53. The system of claim 43, wherein the second information processing system is a group of information processing devices that are operable in concert to receive and reply to submitted bids.

54. A method comprising:
receiving on an information processing device an airline departure location and an airline destination location;
determining in the information processing device a distance between the airline departure location and the airline destination location;
determining in the information processing device an airline ticket cost based on a fixed cost and the distance;
transmitting the airline ticket cost;
receiving purchasing information; and
transmitting an airline ticket purchase confirmation.

55. A computer readable medium with instructions thereon that cause a suitably configured information processing device to perform the method of claim 54.

56. A method, comprising:
offering an airline ticket for sale wherein the ticket is offered for sale using a pricing scheme including a fixed base cost and a variable cost based on a cost per unit distance traveled between a departure and destination location.

57. A system, comprising:
a computing system storing data useful in pricing an airline ticket wherein a ticket is offered for sale using a pricing scheme including a fixed base cost and a variable cost based on a cost per unit distance traveled between a departure and destination location.
